(19) United States
(12) Patent Application Publication
(10) Pub. No.: US 2007/0141997 A1
(43) Pub. Date: Jun. 21, 2007

(54) Radio frequency identification (RFID) antenna integration techniques in mobile devices

(75) Inventors: Thomas Wulff, No. Patchogue, NY (US); Richard T. Knadle JR., Dix Hills, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/300,383

(22) Filed: Dec. 15, 2005

(51) Int. Cl. H04B 1/44

(52) U.S. Cl. 455/78; 455/41.2; 340/572.1; 340/10.1

(57) ABSTRACT

Methods, systems, and apparatuses for mobile devices and antenna thereof, are described herein. A mobile device include RFID reader functionality, and functionality for communicating with one or more wireless networks. A single antenna of the mobile device accommodates the network communication functionality and the RFID reader functionality. The communications network is any type of communications network, including a personal area network (PAN), a local area network (LAN), a wide area network (WAN), or a cell phone network. An antenna pattern of the antenna may be configurable. For example, a gain of the antenna may be varied, the antenna pattern may be shaped, directed, and/or polarized, the antenna pattern may be steered, and/or the antenna pattern may be ranged.

### BACKGROUND OF THE INVENTION

1. Field of the Invention

The present invention relates to radio frequency identification (RFID) systems, and in particular to mobile devices having RFID functionality.

2. Background Art

As the applications and capabilities of mobile devices continue to expand, the amount of electronics required to support these applications and capabilities also increases. With the advent of wireless communications systems, mobile devices can be required to support multiple radio solutions. Example such radio solutions include Personal Area Networks (PAN), Local Area Networks (LAN), and Wide Area Networks (WAN).

The antennas required to support each of these different radios in the mobile device are designed to specific requirements in terms of power, frequency, bandwidth, gain, directionality, etc. The location of the antennas within the mobile device is also crucial to obtain proper antenna performance. As the mobile devices get smaller, the available space to integrate the antennas becomes more limited.

Radio frequency identification (RFID) is a new technology being integrated with mobile devices that requires a radio (e.g., a receiver and transmitter) and a separate antenna for the mobile device. Currently, RFID systems are deployed primarily as accessories to mobile devices, and are not fully integrated therein.

RFID tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed a “reader interrogator” or simply “interrogator”.

It is desired to provide mobile devices with RFID reader functionality. As RFID technology continues to mature and to be exploited in mobile devices, integration techniques are needed to enable RFID reader functionality in mobile devices, while maintaining or even reducing the size of the RFID-enabled mobile devices.

### BRIEF SUMMARY OF THE INVENTION

Methods, systems, and apparatuses for mobile devices and antennas thereof, are described herein. A mobile device includes functionality for communicating with one or more wireless networks, and includes RFID reader functionality. A single antenna of the mobile device accommodates wireless network communication functionality and RFID reader functionality.

In an example, a mobile device includes an antenna, one or more communications modules, each for communicating with a respective network, and a radio frequency identification (RFID) module. A first communications module is coupled to the antenna. Additional communications modules may also be coupled to the antenna. The first communications module is configured to generate a first signal that is transmitted by the antenna over a wireless communications network, and to demodulate a second signal received by the antenna from the wireless communications network. The RFID module is also coupled to the antenna. The RFID module is configured to generate an interrogation signal that is transmitted by the antenna, and to demodulate a tag response signal received by the antenna.

The communications network(s) may be any type of communications network, including a personal area network (PAN), a local area network (LAN), a wide area network (WAN), or a cell phone network.

The antenna pattern of the antenna may be configurable. For example, a gain of the antenna may be varied, the antenna pattern may be shaped, directed, and/or polarized, the antenna pattern may be steered, and/or the antenna pattern may be ranged.

Multiple antennas may be present in the mobile device. For example, separate antennas may be present for one or more of the communications network interface(s) and/or for the RFID functionality.

These and other aspects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with an exemplary population of RFID tags.

FIG. 2 shows an example mobile device, according to an embodiment of the present invention.

FIG. 3 shows an example communications environment in which the mobile device of FIG. 2 can operate.

FIGS. 4-7 show example mobile devices, according to embodiments of the present invention.

FIG. 8 shows an omni-directional antenna pattern for a mobile device.

FIG. 9 shows an example mobile device having beam configuring capability.

FIG. 10 shows example antenna patterns for a mobile device.

FIG. 11 shows a mobile device in a beam steering implementation in a multi-path environment.

FIG. 12 shows a mobile device in a ranging implementation in a multi-path environment.

FIG. 13 shows an example flowchart for operating a mobile device of the present invention.

FIGS. 14 and 15 show examples of mobile devices, according to embodiments of the present invention.

The present invention will now be described with reference to the. accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to radio frequency identification (RFID) enabled mobile devices. Example mobile devices include PALM® devices, personal digital assistants (PDAs), BLACKBERRY® devices, laptop computers, other handheld and/or mobile computing devices, cell phones, etc. In the sections below, an example RFID environment is described, followed by a description of example embodiments for RFID enabled mobile devices.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### EXAMPLE RFID SYSTEM EMBODIMENT

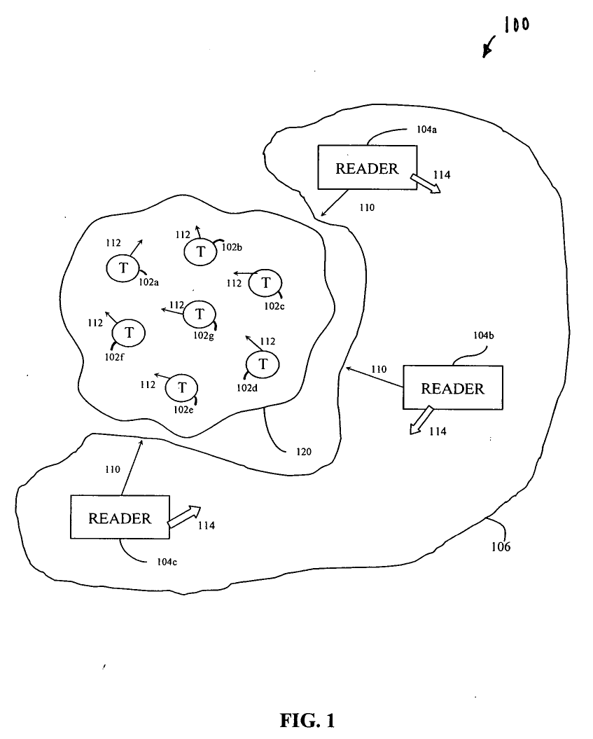

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. It will be apparent to those skilled in the relevant art(s) that population 120 may include any number of tags 102.

Environment 100 includes either a single reader 104 or a plurality of readers 104, such as readers 104a-104c. A reader 104 may be requested by an external application to address the population of tags 120. Alternatively, reader 104 may have internal logic that initiates communication, or may have a trigger mechanism that an operator of reader 104a uses to initiate communication.

As shown in FIG. 1, readers 104 transmit an interrogation signal 110 having a carrier frequency to the population of tags 120. Readers 104 operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting, absorbing, and/or phase shifting portions of signal 110 according to a time-based pattern or modulating frequency. This technique for alternatively absorbing, reflecting, and/or phase shifting signal 110 is referred to herein as backscatter amplitude and/or angular modulation. Readers 104 receive and obtain data from response signals 112, such as an identification number of the responding tag 102.

Interaction between tags and readers typically takes place according to one or more RFID communication protocols, such as those approved by the RFID standards organization EPCglobal (EPC stands for Electronic Product Code). One example of a communication protocol is the widely accepted emerging EPC protocol, known as Generation-2 Ultra High Frequency RFID (“Gen 2”). Gen 2 allows a number of different tag “states” to be commanded by reader interrogators. A detailed description of the EPC Gen 2 protocol may be found in “EPC™ Radio-Frequency Identity Protocols Class-1 Generation-2 UHF RFID Protocol for Communications at 860 MHz -960 MHz,” Version 1.0.7 (“EPC Gen 2 Specification”), and published 2004, which is incorporated by reference herein in its entirety. Examples of RFID protocols applicable to embodiments of the present invention include binary protocols, slotted aloha protocols, and those required by the following standards: Class 0, Class 1, and Gen 2.

Example embodiments for RFID enabled mobile devices are described in the following section. These RFID enabled mobile devices may include some or all of the RFID reader functionality described above.

### EXAMPLE RFID ENABLED MOBILE DEVICE EMBODIMENTS

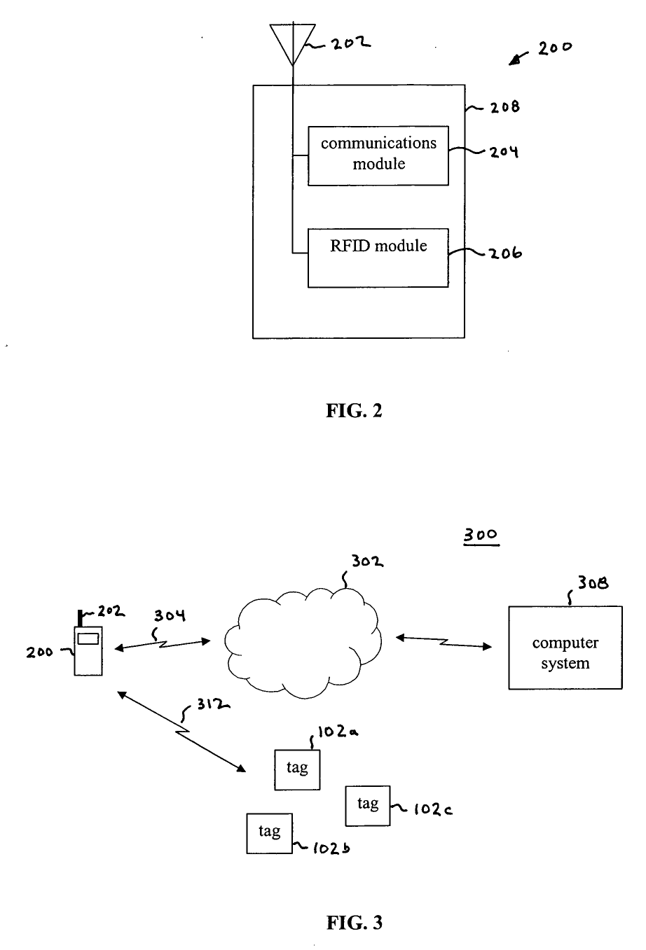

FIG. 2 shows an example mobile device 200. As shown in FIG. 2, mobile device 200 includes an antenna 202, a communications module 204, a RFID module 206, and a housing 208. Communications module 204 and RFID module 206 are each coupled to antenna 202. Antenna 202 allows mobile device 200 to transmit and receive radio frequency (RF) signals, including communicating with RFID tags and remote computer systems and/or networks. Although antenna 202 is shown as a single antenna in FIG. 2, antenna 202 may include any number of one or more antennas.

Communications module 204 provides functionality to enable mobile device 200 to communicate over a wireless communications network, such as one or more of a Personal Area Networks (PAN) (e.g., a BLUETOOTH network), Local Area Networks (LAN) (e.g., wireless LAN—WLAN), and Wide Area Networks (WAN) (e.g., the Internet). Communications module 204 provides for voice and/or data communication (e.g., including E-mail) from mobile device 200. RFID module 206 provides functionality to enable mobile device 200 to communicate with RFID tags. For example, RFID module 206 may include functionality for mobile device 200 described above with respect to readers 104. Modules 204 and 206 may include hardware, software, firmware, or any combination thereof, as needed to perform their respective functions.

Housing 208 contains and/or attaches the elements of mobile device 200. Housing 208 can have various form factors, such that mobile device 200 may be transported by a user, including form factors of a cell phone, a hand-held computing device (e.g., a PALM device or BLACKBERRY device), or a laptop or notebook computer.

FIG. 3 shows an example communications environment 300 in which mobile device 200 operates. Communications module 204 of mobile device 200 is configured to communicate with a network 302 according to bi-directional signal 304. Communications module 204 generates a signal that is transmitted by antenna 202 over network 306 to a remote entity 308, such as a server or computer system. Communications module 204 demodulates a signal received by antenna 202 from network 302.

RFID module 206 of mobile device 200 is configured to communicate with RFID tags 102a-102c according to bi-directional signal 312. RFID module 206 generates an interrogation signal that is transmitted by antenna 202, similar to interrogation signal 110 described above with respect to FIG. 1. RFID module 206 demodulates a tag response signal received by antenna 202, similar to tag response signal 112 described above with respect to FIG. 1.

Mobile device 200 can be a cell phone, a laptop computer, a handheld computing device (e.g., a PALM pilot, personal digital assistant (PDA), BLACKBERRY, etc.), or other device adapted to include communications module 204 and RFID module 206. Alternatively, mobile device 200 can be a special purpose device developed for network and RFID interaction as its primary function.

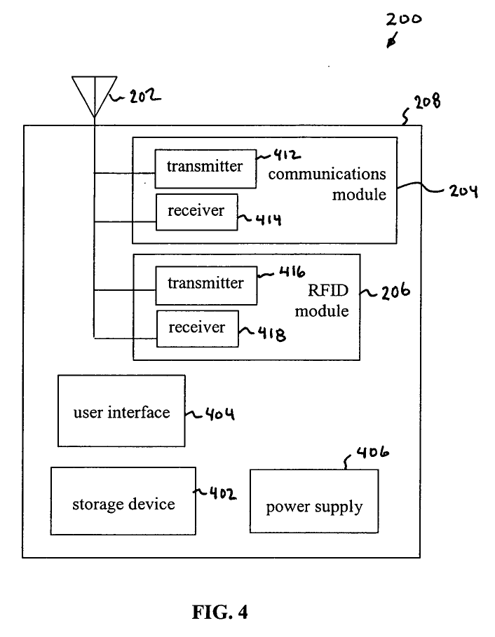

FIG. 4 shows an example mobile device 200, including various example components and/or modules. In FIG. 4, mobile device 200 includes communications module 204, RFID module 206, a storage device 402, a user interface 404, and a power supply 406. In FIG. 4, each of communications module 204 and RFID module 206 include their own radio functionality. Communications module 204 includes a transmitter 412 and a receiver 414, and RFID module 206 includes a transmitter 416 and a receiver 418. In an alternative embodiment, communications module 204 and RFID module 206 may share a common receiver and transmitter (or transceiver). The transmitters and receivers may be those that are present in commercial off-the-shelf versions of mobile device 200, such as the transmitter and receiver (or transceiver) present in a cell phone or a WLAN card. Alternatively, they may be installed in mobile device 200 for use with embodiments of the present invention.

A user interacts with mobile device 200 through user interface 404. For example, user interface 404 can include any combination of one or more finger-operated buttons (such as a “trigger”), a keyboard, a graphical user interface (GUI), indicator lights, and/or other user input and display devices, for a user to interact with mobile device 200, to cause mobile device 200 to operate as described herein. User interface 404 may further include a web browser interface for interacting with web pages and/or an E-mail tool for reading and writing E-mail messages.

Storage device 402 is used to store information/data for mobile device 200. Storage device 402 can be any type of storage medium, including memory circuits (e.g., a RAM, ROM, EEPROM, or FLASH memory), a hard disk/drive, a floppy disk/drive, an optical disk/drive (e.g., CDROM, DVD, etc), etc., and any combination thereof. Storage device 402 can be built-in storage of mobile device 200, and/or can be additional storage installed in mobile device 200.

Power supply 406 can be any suitable power source for mobile device 200, including one or more batteries.

Note that, depending on the particular application for the mobile device, mobile device 200 may include additional or alternative components. For example, mobile device 200 may include machine readable symbol scanner (e.g., barcode scanner) functionality for scanning machine readable symbols (e.g., barcodes). A communication module 204 of mobile device 200 may be used to transmit scanned machine readable symbol data from mobile device 200, if desired.

Conventionally, multiple antennas must be integrated into a single mobile device to enable communications using multiple communications mediums. This is difficult due to the relatively small size of mobile devices. The present invention enable a single antenna to handle the multiple communications, thus reducing issues due to the size constraints of mobile devices.

For example, mobile devices frequently communicate using multiple, different frequencies. Many WAN radios operate at tri-band, or quad-band frequencies. Embodiments of the present invention take advantage of the characteristic that some of these operating frequencies overlap with RFID radio operating frequencies, and thus the two (or more) mediums may be handled with a single antenna 202. For example, communications module 204 may be capable of communicating over the WAN 900 GSM band, which operates from 880 MHz to 960 MHz. RFID module 206 may be capable of communicating over the ISM RFID U.S. band, which operates from 902 MHz to 928 MHz. Thus, a single antenna 202 of mobile device 200 is used to communicate for both of these bands. In such an embodiment, communications module 204 and RFID module 206 may communicate simultaneously using antenna 202 (i.e., in an overlapping manner), or may communicate in a non-overlapping fashion over antenna 202, such as by using an antenna switch or a duplexing filter.

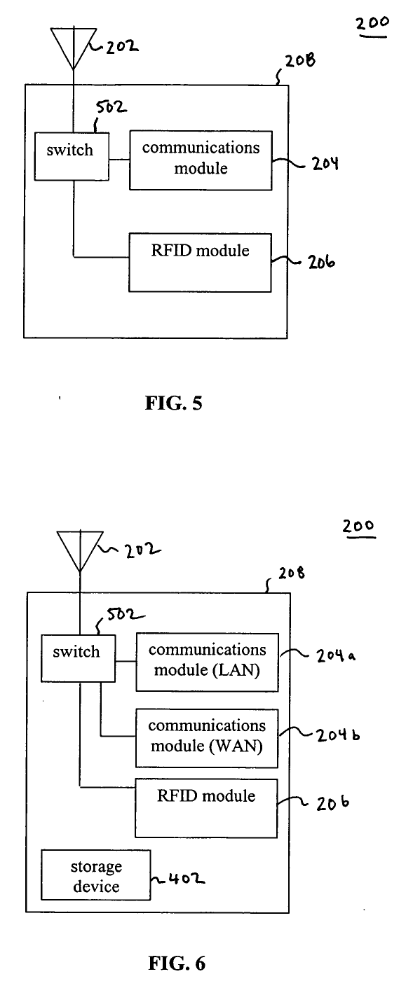

FIGS. 5-7 show example embodiments for mobile device 200. As shown in FIG. 5, mobile device 200 includes a switch 502. Switch 502 is coupled between antenna 202 and communications module 204, and between antenna 202 and RFID module 206. Switch 502 enables communications module 204 or RFID module 206 to communicate using antenna 202, one at a time. Thus, in a first setting or position for switch 502, switch 502 couples communications module 204 to antenna 202 so that it can transmit and receive signals, while RFID module 206 is not coupled to antenna 202. In a second setting or position for switch 502, switch 502 couples RFID module 206 to antenna 202 so that it can transmit and receive signals, while communications module 204 is not coupled to antenna 202. When additional communication modules 204 are present in mobile device 200 (such as shown in FIG. 6, described below) (e.g., so that mobile device 200 can communicate over multiple networks, such as PAN, LAN, WAN, etc.), switch 502 may also allow for switching between the additional communication modules 204.

The operation of switch 502, when present, can be automatic (such as by including “application recognition” functionality) or manual, depending on the particular user application. In an automatic application, communications module 204 and/or RFID module 206 can provide one or more control signals to switch 502 to control its setting or position. The one or more control signals can dictate the operation of switch 502 based on the operation of one or more of communications module 204 and RFID module 206.

For example, as shown in FIG. 6, mobile device 200 may include functionality enabling communication over a LAN and over a WAN. As shown in FIG. 6, a first communications module 204a may be present for communicating over a LAN, and a second communications module 204b may be present for communicating over a WAN. For instance, it may be desired to communicate data collected by RFID module 206 while interrogating tags, and/or communicate barcode data captured by a scanner of mobile device 200, using the LAN configured communications module 204a. Mobile device 200 may desire to communicate with access points of a LAN while mobile device 200 is being used in a warehouse, distribution center, factory, or other environment. In such an implementation, switch 502 decouples the WAN radio of second communications module 204b from antenna 202, and defaults to the LAN radio of first communications module 204a. In this mode, mobile device 200 can use RFID module 206 (using the same or different antenna 202) to capture tag data and/or use a scanner to capture barcode data, store the data in storage (e.g., storage device 402), and use the LAN radio of first communications module 204a to communicate the data from mobile device 200. When mobile device 200 is finished communicating on the LAN network, switch 502 may switch over to the WAN radio of second communications module 204b, which may a default switch position. A default setting for switch 502 may be for any one of communications module(s) 204 and RFID module 206.

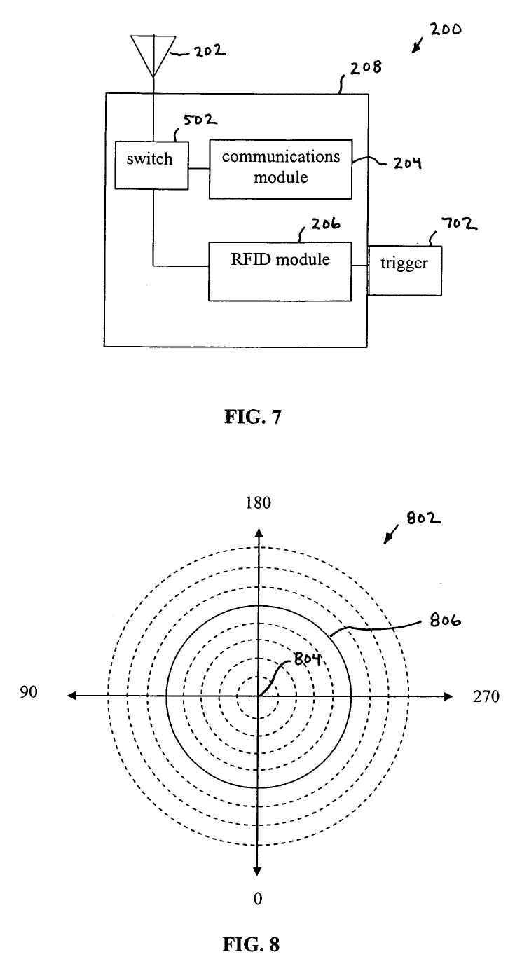

Manual switching can be accomplished many ways. For example, FIG. 7 shows an example embodiment for mobile device 200, incorporating manual switching. As shown in FIG. 7, mobile device 200 includes a user-operated trigger 702, coupled to RFID module 206. Trigger 702 can be any triggering mechanism, such as a button, a finger-operated pull-trigger, etc. Trigger 702 may be included in user interface 404 of FIG. 4. In the current example, a default setting for switch 502 may be used to couple the WAN radio of communications module 204 to antenna 202. Upon a user pressing trigger 702, switch 502 changes to an “RFID” position, causing RFID module 206 to operate (e.g., interrogating tags), while postponing any WAN radio transactions of communications module 204 until trigger 702 is released by the user. When mobile device 200 includes both a LAN and WAN radio, such as shown in FIG. 6, pressing trigger 702 may enable RFID module 206 to operate, and enable the LAN radio to transmit acquired tag data from mobile device 200 to a LAN.

In another embodiment, switch 502 is not present, and is not required for operation of mobile device 200. In such an implementation, communication module(s) 204 and RFID module 206 may be configured to communicate through antenna 202 simultaneously. Thus, mobile device 200 includes the proper circuitry, proper modulation scheme(s), duplexing filter(s), de-sense, etc. to enable transmitting and receiving of signals simultaneously by communication modules 204 and RFID module 206 using antenna 202. Such configuration details will be apparent to persons skilled in the relevant art(s) in light of the teachings herein.

Typically, antennas of mobile devices for WAN communications operate according to an omni-directional antenna pattern, such as shown in FIG. 8. FIG. 8 shows a top-down view of a graph 802 of an omrni-directional antenna pattern 806 produced by an antenna located at an origin 804, where the gain of the radiating antenna is uniform. The dotted circles of graph 802 each represent a loci of a constant gain, with gain decreasing as distance from origin 804 increases. Omni-directional antenna pattern 806, shown as a solid line, is an example omni-directional antenna pattern having a particular gain level.

As shown in FIG. 8, omni-directional antenna pattern 806 has a circular azimuthal pattern. An omni-directional antenna pattern such as shown in FIG. 8 ensures that the mobile device will obtain reasonable network connection performance with regard to surrounding network connection points in the azimuthal directions, such as with cell towers.

In an embodiment where antenna 202 may be switched or shared between two radios (such as in FIG. 5), the antenna gain when coupled to RFID module 206 is configured to have an omni-directional antenna pattern. This provides the RFID system with the capability to read tags in all directions. The spreading of RF energy in a uniform, omni-directional pattern as in FIG. 8 limits read range, however. For mobile device applications where reading surrounding tags in all directions is of primary interest, and increased range is not important, omni-directional antenna pattern 806 may be sufficient or desired.

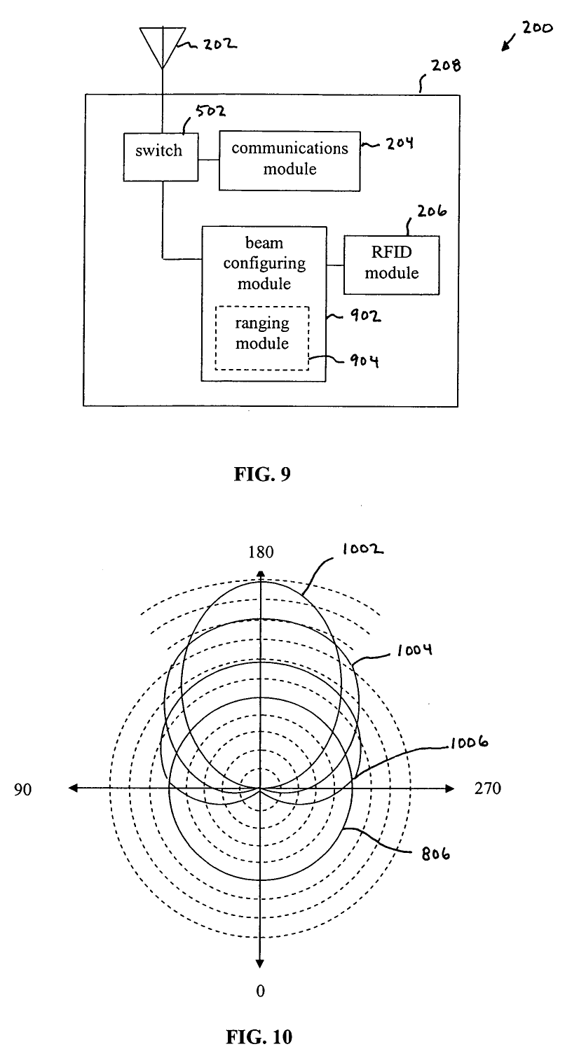

In other embodiments, beam forming and/or beam shaping (BFBS) techniques may be used to change the antenna pattern of antenna 202 to enhance operation. FIG. 9 shows a mobile device 200 that includes a beam configuring module 902. Beam configuring module 902 enables beam forming and/or beam shaping for an antenna pattern radiated by antenna 202.

In FIG. 9, beam configuring module 902 is shown coupled between RFID module 206 and antenna 202. Thus, in this implementation, beam configuring module 902 enables configuring of an antenna pattern during RFID operation of mobile device 200. However, in an alternative embodiment, beam configuring module 902 may additionally or alternatively provide beam configuring capability for one or more communications modules 204.

Beam configuring module 902 may be configured to generate a directional antenna pattern for antenna 202, such as where long-range solutions are required. FIG. 10 shows various example antenna patterns that may be configured using beam configuring module 902, according to example embodiments of the present invention. For instance, FIG. 10 shows an example directional antenna pattern 1002. Directional antenna pattern 1002 focuses radiated RF energy into a narrower beam in a forward sector (shown as the 180-degree direction in FIG. 10) as compared to omni-directional antenna pattern 806.

Beam configuring module 902 enables re-configuring of antenna parameters, such as antenna gain and antenna pattern shape. For example, antenna gain can be configured to emphasize a particular desired communications range, such as low, medium, and high antenna gain for short, medium, or long reading ranges, respectively. Furthermore, the shape of the antenna pattern itself can be changed to emphasize similar factors and/or specific coverage area shapes.

In an embodiment, the antenna pattern is switched through the use of an antenna switch, such as switch 502 of FIG. 5. For example, omni-directional antenna pattern 806 can be used (e.g., for optimum cell tower coverage) when operating a WAN radio, such as communications module 204b of FIG. 6. When switching over to a LAN radio, such as communication module 204a (e.g., to transmit an E-mail and/or RFID data to a LAN), the antenna pattern could become more directional, such as by using directional antenna pattern 1002. The increased directionality provides higher gain and range in the forward sector when communicating with the LAN. In another embodiment, antenna gain is switched from an omni-directional gain pattern, to an intermediate directional gain pattern such as a cardioid gain pattern, and then to a more fully directional gain pattern, such as a cone shaped gain pattern, to provide a variety of coverage patterns.

In a further embodiment, beam configuring module 902 is configured to enable transmitting and receiving of polarized RF signals, including horizontally polarized, vertically polarized, clockwise circularly polarized, counter-clockwise circularly polarized, etc. The ability to control polarization is advantageous when attempting to read tags that are physically oriented in a random direction, for example. Furthermore, this provides another selection criteria that can be used to select spatial areas where the tags are desired to be read. Configuration details for generating polarized patterns will be apparent to persons skilled in the relevant art(s) in light of the teachings herein.

Polarization of signals may be used for tag selectivity when interrogating tags. For example, a user can intentionally position a first portion of tags to be oriented horizontally, and position a second portion of tags to be oriented vertically. Through the use of polarized interrogation signals, the differently oriented tags can be separately read. Thus, a user of a mobile device with polarization capability can read the first portion of tags using a polarization that reads horizontally oriented tags. Furthermore, the user can select (or it can be switched automatically) a second polarization that reads the vertically oriented tags. The reconfigurable polarization antenna allows the mobile device user to not have to torsionally twist his/her wrist in order to locate the second portion of tags

In a similar fashion, this technique can be used to read tags that have both a horizontal antenna element and a vertical antenna element, within the same tag. Beam configuring module 902 can be configured to allow a user of mobile device 200 to selectively communicate with the separate antenna elements of such a tag. For example, a high-valued-product tag can be configured to have separate identification numbers corresponding to each antenna element. The identification number for each antenna element is separately addressed to fully read the tag. Different polarizations can be used by mobile device 200 to read each of the identification numbers through the differently oriented antenna elements. This configuration insures higher security in the tag-reading operation, and may be useful in the proper identification of tagged-personnel or tagged-hardware, in a military application, for example.

Conventional beam forming and beam shaping techniques can be implemented in beam configuring module 902 to form and/or shape antenna patterns as described herein, and will be known to persons skilled in the relevant art(s). Beam configuring module 902 enables antenna performance to be configured for a specific communication medium (e.g., RFID, PAN, LAN, WAN) and/or for a specific application. Beam configuring module 902 can include hardware, software, firmware, or any combination thereof, to perform its functions.

FIG. 10 shows second and third directional antenna patterns—first cardioid antenna pattern 1004 and cardioid antenna pattern 1006. The radiated antenna pattern of antenna 202 can be switched from a less directional gain pattern to one (or more) of cardioid antenna patterns 1004 and 1006 and directional antenna pattern 1002 to yield higher gain in the forward direction. Higher gain in the forward direction can be used in conjunction with the operation of RFID module 206 to enable longer RFID read ranges.

As shown in FIG. 9, beam configuring module 902 can include a ranging module 904. Ranging module 904 enables beam configuring module 902 to “range” between different antenna patterns and/or characteristics, such as antenna gains, during operation of RFID module 206 for interrogation of tags. For example, ranging module 904 enables beam configuring module 902 to “range” from one to another of omni-directional antenna pattern 806, cardioid antenna pattern 1006, first directional antenna pattern 1002, and second directional antenna patterns 1004, as desired in a particular application.

As shown in FIG. 10, omni-directional antenna pattern 806 has less range, and thus can read tags at a shorter range surrounding origin 804. Second cardioid antenna pattern 1006 increases gain in the forward sector, while reducing the gain in the rear sector (i.e., in the direction of 0-degrees in FIG. 10), with some gain in the right and left sectors (i.e., in the directions of 270-degrees and 90-degrees, respectively). First cardioid pattern 1004 further increases gain in the forward sector while reducing gain in the rear, right, and left sectors, relative to second cardioid pattern 1006. Directional antenna pattern 1002 provides higher gain in the forward sector with substantially no gain in the rear sector, relative to first and second cardioid antenna patterns 1004 and 1006.

RFID module 206 ranges or shifts through various antenna patterns while in search mode (or “homing” mode), to search for tags. In an embodiment, the search is initiated with a relatively close range omni-directional antenna pattern (e.g., pattern 806), and shifts to one or more of cardioid (e.g., patterns 1004 and 1006) and/or directional patterns (e.g., pattern 1002). For example, RFID module 206 may operate by default in an “omni” mode, using a more omni-directional antenna pattern to orient a user in a desired direction, such as a warehouse, where there are tags located near a particular tag that the user is searching for. For example, the tags may have common date codes, product codes, etc., with the particular desired tag. Upon locating these tags, ranging module 904 determines their general direction, and begins ranging to determine a more specific direction for the tags, such as a particular sector of the warehouse. Ranging module 904 causes beam configuring module 902 to change to a more directional antenna pattern, to focus on a specific grouping of tags that are closer to the particular desired tag. Lastly, ranging module 904 causes beam configuring module 902 to change to even more directional antenna patterns until the particular desired tag is successfully interrogated. Ranging module 904 can range through multiple antenna patterns automatically in a short amount of time, including, for example, in a few milli-seconds.

In another embodiment, ranging module 904 can use ranging to reduce multi-path issues. In general, RF energy reflects and bounces off many surfaces and shapes. RF energy can also be absorbed and blocked by certain materials. Ideally, RFID readers transmit and receive RF energy in a straight line of sight to the RFID tags. However, in real implementations, this is rarely the case. Instead, the RF energy travels along a plurality of, or multiple, paths to the tag. These “multi-paths” are the product of the RF energy bouncing, reflecting, and/or being nulled by objects in the environment, including floors, walls, cans, people, liquids, etc. RFID readers can sometimes have “dead zones” where the RF multi-paths are nulled due to the surrounding objects and environment. To correct for these dead zones, typically a user of the mobile device must change their geometric position with respect to the tag. This change in geometric position shifts RF energy paths in an attempt to enable a better multi-path solution to the tag.

According to an embodiment, ranging module 904 shifts or ranges through a plurality of antenna pattern shapes when searching for a tag. Ranging through the antenna patterns increases the amount of multi-path solutions over which communications are attempted between antenna 202 and the tag, without the user being required to change their geometric position.

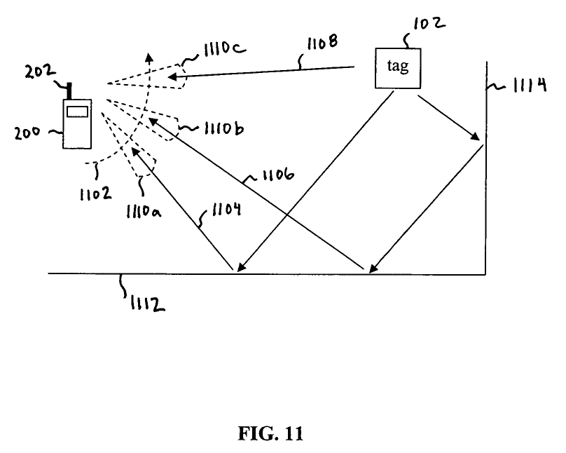

FIG. 11 shows mobile device 200 in a beam steering implementation in a multi-path environment, according to an example embodiment of the present invention. In FIG. 11, antenna 202 of mobile device 200 is radiating an antenna pattern 1110 steering in the direction of arrow 1102. At three points along arrow 1102, antenna 202 receives the same tag response from tag 102, but on different paths—first path 1104, second path 1106, and third path 1108. Antenna pattern 1110a is a position along arrow 1102 that receives the tag response along first path 1104. Antenna pattern 1110b is a position along arrow 1102 that receives the tag response along second path 1106. Antenna pattern 1110c is a position along arrow 1102 that receives the tag response along third path 1108. As shown in FIG. 11, first path 1104 is an indirect path to antenna 202, reflecting once off a floor 1112. Second path 1106 is also an indirect path to antenna 202, reflecting off a wall 1114 and floor 1112. Third path 1108 is a direct path to antenna 202. Ranging module 904 determines that the strongest signal is received on third path 1108, which may be strongest because it is the shortest path, the response is not reflected, etc. Beam configuring module 902 may lock into using antenna pattern 1110c, which is radiating in the direction of third path 1108, for further communications with tag 102 and/or other tags in its vicinity.

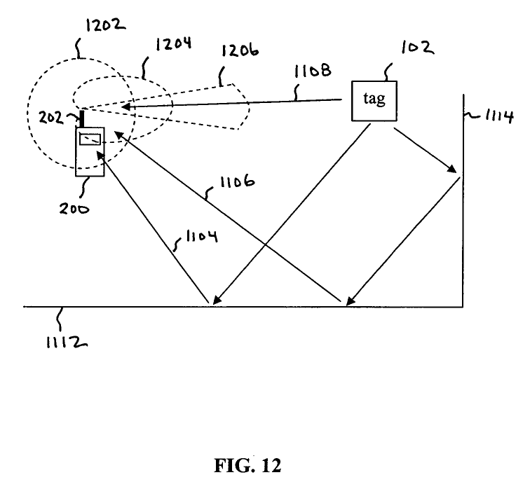

FIG. 12 shows mobile device 200 in a beam ranging implementation in a multi-path environment. In FIG. 12, antenna 202 of mobile device 200 radiates a first antenna pattern 1202, which is an omni-directional antenna pattern. As shown in FIG. 12, omni-directional first antenna pattern 1202 receives a response from tag 102 along all of first, second, and third paths 1104, 1106, and 1108. Due to the multiple paths, the tag response may be difficult or impossible to accurately demodulate.

For example, a wavelength of an RF signal is approximately 1 foot long. Individual multipath signals (e.g., signals received along first, second, and third paths 1104, 1106, and 1108) can differ from each other in total path length by amounts including fractions of a foot to multiple feet. Each foot of path length difference represents a phase shift (delay difference) of approximately 360 degrees of the RF signal. Thus, in a multipath situation, multiple signals combine in a vector manner. RF signal vectors each have a magnitude and a phase angle. Thus, they can be combined into a composite signal vector having a resultant magnitude and phase angle.

In some multipath situations, the multipath signals combine into a nearly zero-sized resultant signal vector, referred to as an “RF null.” This may occur for two (nearly equal) signals 180 degrees out of phase, three signals 120 degrees out of phase (e.g., at 0, 120, and 240 degrees), and many other combinations of signals.

If mobile device 200 is located in an RF null, it may not receive a response from tag 102. To avoid a multipath null situation, an operator of mobile device 200 can change their position (which shifts the relative phase angles due to the multipath signals received from tag 102). Alternatively, the operator can change the relative signal amplitudes of the multipath signals by changing the antenna pattern, or the boresight aiming (direction) of the antenna pattern.

Thus, to overcome a multipath null problem, in an embodiment, ranging module 904 can range between antenna patterns. This ranging causes a change in the relative magnitudes of the multipath signals and/or their relative phase angles, to reduce or eliminate the RF null. For example, ranging module 904 ranges the antenna pattern of antenna 202 to a second antenna pattern 1204, which is a cardioid antenna pattern, to potentially change amplitudes and/or phase angles of reflected signals. Second antenna pattern 1204 receives the tag response along second and third paths 1106 and 1108. Again, due to new multipaths, a new RF null problem could arise, making the tag response difficult or impossible to accurately demodulate, although perhaps easier to read than with first antenna pattern 1202. Ranging module 904 can range the antenna pattern of antenna 202 to a third antenna pattern 1206, which is a directional antenna pattern. Ranging module 904 can continue to range until an antenna pattern setting is found that suffers from little or no multi-path issues, as do first and second antenna patterns 1202 and 1206 (in the current example). In this manner, tags can be more rapidly and efficiently read.

Any of first, second, and third antenna patterns 1202, 1204, and 1206 may turn out to be a desirable antenna pattern. Any shape of antenna pattern and/or number of antenna patterns may be ranged through.

In an embodiment, a user interface 404 (shown in FIG. 4) of mobile device 200 could display a bar graph, or other visual or tonal feedback (for instance), that indicates to an operator of mobile device 200 when he/she is proceeding in the correct azimuth and/or elevation direction to locate a particular tag. Beam steering, as described herein, can be used to emphasize tags in a particular direction, while rejecting tags in another direction. This may be advantageous in numerous applications, including when attempting to locate and read tags that are not addressable, such as more sensitive tags interrogated according to the “Aloha” protocol.

In an embodiment, antenna gain is lowered through the use of lossy materials within the structure and/or a transmission line of antenna 202. For example, during the period of time that short-range-reading, or medium-range-reading is desired, the lossy materials can be used to re-configure the antenna for low gain or medium gain. This technique of altering antenna gain can have the advantage of simultaneously lowering the voltage standing wave ratio (VSWR), or Reflected Power Ratio, from antenna 202. The receiver section of RFID module 206, coupled to antenna 202 using this technique, can have the advantage of a decrease in receiver desensitization that can accompany strong RF reflections, as described above. A total of the RF-reflected power from an antenna system can be a direct result of: (1) the VSWR of the antenna itself; and (2) the RF reflections from objects that are placed in front of the antenna. The gain-reducing lossy materials described above absorb a portion of the reflected power from either of causes (1) and (2). Thus, dynamic range of the receiver is increased, and Intermodulation Distortion (IM) of the receiver is decreased. This decreases the vulnerability to IM-caused spurious receiver responses when multiple signal sources are present within an environment.

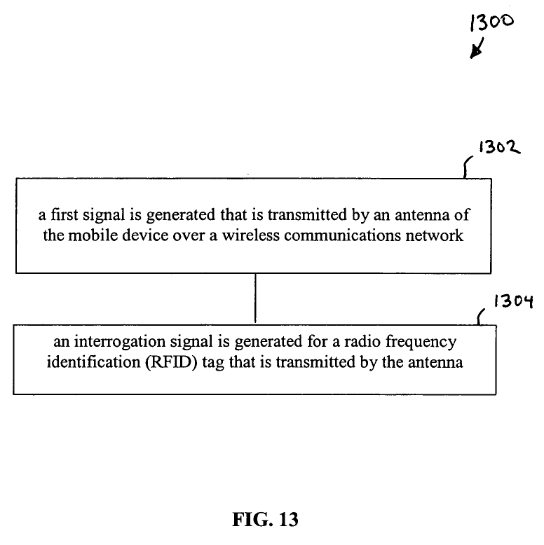

Thus, one or more communication modules for communicating with remote networks, and an RFID module for interrogating tags, are present in a mobile device, sharing an antenna. FIG. 13 shows an example flowchart 1300 for operating a mobile device of the present invention. The steps of flowchart 1300 can occur in either order. The steps of flowchart 1300 are described in detail below.

In step 1302, a first signal is generated that is transmitted by an antenna of the mobile device over a wireless communications network. For example, the first signal is generated by communication module 204 of FIG. 2, and transmitted by antenna 202, to communicate with a wireless network such as a PAN, LAN, or WAN. Furthermore, the mobile device is configured to demodulate a second signal received by the antenna from the wireless communications network. For example, communications module 204 may perform the demodulation of the second signal, which may be a response signal to the first signal received from the wireless network.

In step 1304, an interrogation signal is generated for a radio frequency identification (RFID) tag that is transmitted by the antenna. For example, the interrogation signal may be generated by RFID module 206 of FIG. 2, and transmitted by antenna 202, to interrogate the tag. Furthermore, the mobile device is configured to demodulate a tag response signal received by the antenna. For example, RFID module 206 may perform the demodulation of the tag response signal received from the tag.

Flowchart 1300 may include further steps. For example, further communication modules may be present in the mobile device, to perform further communications with additional remote networks and/or entities. Furthermore, step 1302 and/or 1304 may include steps related to antenna pattern configuring, such as performed by beam configuring module 902 of FIG. 9. Example antenna pattern configuring includes: (a) varying a gain of the antenna; (b) shaping an antenna pattern of the antenna, such as shaping the antenna pattern in one of a cardioid or directional pattern; (c) directing an antenna beam of the antenna, (d) polarizing an antenna pattern of the antenna, including horizontally polarizing, vertically polarizing, or circularly polarizing the antenna pattern; (e) steering an antenna beam of the antenna, including steering the antenna beam in the azimuth or elevation direction; and (f) ranging an antenna pattern of the antenna through a series of antenna patterns, including ranging the antenna pattern through a plurality of signal paths between the antenna and a tag to address issues of multi-paths.

### ADDITIONAL EXAMPLE MOBILE DEVICE EMBODIMENTS

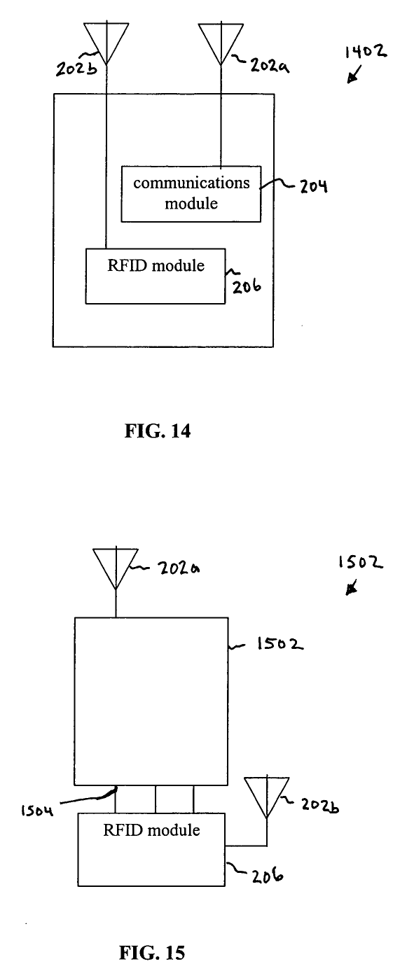

FIG. 2 described above shows an exemplary mobile device 200. Further examples for mobile devices are shown in FIGS. 14 and 15. The mobile devices of FIGS. 2, 14, and 15 show various ways that antenna(s) 202 may be incorporated into, or associated with elements of a mobile device, for illustrative purposes. Further configurations for mobile devices will be understood to persons skilled in the relevant art(s) from the teachings herein. As described above, a mobile device of the present invention can be a commercially available device, such as a cell phone or PDA, that includes the functionality of at least one communications module 204 and RFID module 206, or can be a special purpose device.

Referring to FIG. 2, communications module 204 and RFID module 206 may each include hardware, software, firmware, or any combination thereof, including software or firmware that is downloaded into mobile device 200.

As shown in FIG. 2, mobile device 200 has a single antenna 202. Thus, in the embodiment of FIG. 1, antenna 202 is configured to transmit and/or receive signals of the frequencies required by mobile device 200. For example, if mobile device 200 is a cell phone, and communications module 204 is configured to communicate over a cellular network, antenna 202 is configured to transmit and/or receive signals in cell phone frequency ranges. Furthermore, antenna 202 is configured to transmit and/or receive signals in a frequency range required by the RFID features of mobile device 200. Thus, antenna 202 can transmit RFID reader frequencies and can receive tag responses.

FIG. 14 shows a mobile device 1402. As shown in FIG. 14, mobile communication device 1402 includes communications module 204 and RFID module 206. Communications module 204 and RFID module 206 each includes software, hardware, firmware, or any combination thereof, stored or housed in mobile device 1402.

As shown in FIG. 14, mobile device 1402 has a first antenna 202a and a second antenna 202b. In the embodiment of FIG. 14, first antenna 202a is used to transmit and/or receive signals of a first frequency range, and second antenna 202b is used to transmit and/or receive signals of a second frequency range. For example, first antenna 202a may be used to allow mobile device 1402 to communicate over a communications network, such as a LAN, PAN, or WAN, or to operate as a cell phone. Thus, first antenna 202a may be configured to transmit and/or receive signals in WLAN 802.11 or cell phone frequency ranges, for example. Second antenna 202b is configured to transmit and/or receive signals in a frequency range required by the RFID features of mobile device 1402. Mobile devices can have additional antennas, if desired and/or needed.

Alternatively, relating mobile device 1402 to the implementation of FIG. 6 described above, first antenna 202a may be coupled to communications module 204a and RFID module 206, while second antenna 202b is coupled to communications module 204b. When multiple antennas 202 are present, they may be coupled to communication module(s) 204 and RFID module 206 in any combination.

Mobile device may include an array of antennas or discrete antenna elements. Such an array may be used in beam steering and ranging embodiments, for example. For instance, the antennas may be of the same type, and spaced and phased so that their individual contributions add in a desired direction, while canceling in other directions. For example, the antenna elements may be arranged in a linear array, or other array configuration. The contribution of each antenna element to the array can be controlled to control configuration of the resulting antenna pattern. Thus, beam configuring module 902, including ranging module 904, may be configured to operate an array of antenna elements to perform beam steering, ranging, etc., in embodiments. For further description of antenna arrays, beam steering, and searching/homing applications, refer to Johnson, Richard C., “Antenna Engineering Handbook,” Third Edition, McGraw-Hill, Inc., copyright 1993, the contents of which is incorporated by reference in its entirety herein.

FIG. 15 shows a mobile device 1502. As shown in FIG. 15, RFID module 206 is an external plug-in module that attaches to mobile device 1502 (communications module 204 is not shown in FIG. 15). RFID module 206 plugs into an interface 1504 of mobile device 1502, such as a serial port, a parallel port, a USB port, or other data port or interface type. The interface can be an accessory port, an infrared port, or any other interface or port capable of transferring data to and from mobile device 1002 such as a wireless phone data/software interface.

Furthermore, as shown in FIG. 15, RFID module 206 includes an optional second antenna 202b. By attaching RFID module 206 (with second antenna 202b) to a commercially available mobile device 1502 having a single antenna, such as a cell phone, the device can be converted into a multi-antenna device capable of communicating at WAN/LAN/PAN, cell phone, and/or RFID reader/tag frequency ranges. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A mobile device, comprising:
an antenna;
a communications module coupled to the antenna, wherein the communications module is configured to generate a first signal that is transmitted by the antenna over a wireless communications network, and to demodulate a second signal received by the antenna from the wireless communications network; and
a radio frequency identification (RFID) module coupled to the antenna, wherein the RFID module is configured to generate an interrogation signal that is transmitted by the antenna, and the RFID module is configured to demodulate a tag response signal received by the antenna.

2. The mobile device of claim 1, wherein the wireless communications network is any one or more of a personal area network (PAN), a local area network (LAN), or a wide area network (WAN).

3. The mobile device of claim 1, further comprising a switch, wherein the switch couples one of the communications module or the RFID module to the antenna according to a control signal.

4. The mobile device of claim 3, further comprising a user input device that generates the control signal.

5. The mobile device of claim 4, wherein the user input device is a finger-operated trigger mechanism coupled to the mobile device.

6. The mobile device of claim 3, wherein the control signal is generated by the communications module.

7. The mobile device of claim 6, wherein if the communications module is transmitting the first signal or receiving the second signal, the control signal causes the switch to couple the communications module to the antenna.

8. The mobile device of claim 1, further comprising:
a beam configuring module coupled to the antenna.

9. The mobile device of claim 8, wherein the beam configuring module is configured to vary a gain of the antenna.

10. The mobile device of claim 8, wherein the beam configuring module is configured to shape an antenna pattern of the antenna.

11. The mobile device of claim 10, wherein the beam configuring module is configured to shape the antenna pattern in cardioid and directional patterns.

12. The mobile device of claim 8, wherein the beam configuring module is configured to direct an antenna beam of the antenna.

13. The mobile device of claim 8, wherein the beam configuring module is configured to polarize an antenna pattern of the antenna.

14. The mobile device of claim 8, wherein the beam configuring module is configured to horizontally polarize, vertically polarize, or circularly polarize the antenna pattern.

15. The mobile device of claim 8, wherein the beam configuring module is configured to steer an antenna beam of the antenna.

16. The mobile device of claim 15, wherein the beam configuring module is configured to steer the antenna beam in the azimuth and elevation directions.

17. The mobile device of claim 1, wherein the mobile device is a cell phone, a mobile hand-held computer, or a personal digital assistant (PDA).

18. The mobile device of claim 1, further comprising a duplexing filter, wherein the duplexing filter couples one of the communications module or the RFID module to the antenna according to a control signal.

19. A method for a mobile device, comprising:
generating a first signal that is transmitted by an antenna of the mobile device over a wireless communications network, wherein the mobile device is configured to demodulate a second signal received by the antenna from the wireless communications network; and
generating an interrogation signal for a radio frequency identification (RFID) tag that is transmitted by the antenna, wherein the mobile device is configured to demodulate a tag response signal received by the antenna.

20. The method of claim 19, wherein the wireless communications network is a personal area network (PAN), a local area network (LAN), or a wide area network (WAN).

21. The method of claim 19, further comprising:
switching the antenna between a communications module that generates the first signal and a RFID module of the mobile device that generates the interrogation signal, according to a control signal.

22. The method of claim 21, further comprising:
enabling a user to interact with a user input device of the mobile device to generate the control signal.

23. The method of claim 21, further comprising:
generating the control signal when transmitting the first signal or receiving the second signal.

24. The method of claim 19, further comprising:
configuring an antenna pattern of the antenna.

25. The method of claim 24, wherein said configuring comprises:
varying a gain of the antenna.

26. The method of claim 24, wherein said configuring comprises:
shaping an antenna pattern of the antenna.

27. The method of claim 26, wherein said configuring comprises:
shaping the antenna pattern in one of a cardioid or directional pattern.

28. The method of claim 24, wherein said configuring comprises:
directing an antenna beam of the antenna.

29. The method of claim 24, wherein said configuring comprises:
polarizing an antenna pattern of the antenna.

30. The method of claim 24, wherein said polarizing comprises:
horizontally polarizing, vertically polarizing, or circularly polarizing the antenna pattern.

31. The method of claim 24, wherein said configuring comprises:
steering an antenna beam of the antenna.

32. The method of claim 31, wherein said steering comprises:
steering the antenna beam in the azimuth or elevation direction.

33. The method of claim 19, further comprising:
ranging an antenna pattern of the antenna a plurality of antenna patterns.

34. The method of claim 33, wherein said ranging comprises:
ranging to a second antenna pattern from a first antenna pattern to avoid a RF null present due to the first antenna pattern.

35. The method of claim 24, wherein said ranging comprises:
ranging the antenna pattern through a plurality of signal paths between the antenna and a tag.

36. A method for a mobile device, comprising:
enabling a user to interact with a mobile device to generate a first signal that is transmitted by an antenna of the mobile device over a wireless communications network, wherein the mobile device is configured to demodulate a second signal received by the antenna from the wireless communications network; and
enabling a user to interact with the mobile device to generate an interrogation signal for a radio frequency identification (RFID) tag that is transmitted by the antenna, wherein the mobile device is configured to demodulate a tag response signal received by the antenna.
